(19) United States
(12) Patent Application Publication
(10) Pub. No.: US 2002/0163479 A1
(43) Pub. Date: Nov. 7, 2002

(54) Printed radio frequency sensing cards and fabricating methods therefor

(76) Inventors: Wei-Kang Lin, Taipei (TW); Chih-I Lin, Chino Hills, CA (US); Shih-Yu Tsou, Taipei (TW); Shengfu Lin, Taipei (TW)

Correspondence Address: BACON & THOMAS, 625 Slaters Lane - 4th Floor, Alexandria, VA, 22314, US

(21) Appl. No.: 10/134,530

(22) Filed: Apr. 30, 2002

(30) Foreign Application Priority Data
May 4, 2001 (TW) 90110780

(51) Int. Cl. H01P 11/00; H01Q 13/00; H01Q 1/36

(52) U.S. Cl. 343/895; 29/600

(57) ABSTRACT

A fabricating method of the printed radio frequency sensing card includes a first step in which a printed circuit board substrate is provided in two sides with a coil circuit and an implantation hole. These two coil circuits are connected by a through hole connection to form a single coil circuit having two ends. An identification IC is mounted to the implantation hole such that the identification IC is electrically connected with the ends of the single coil circuit at two points, which are on two surfaces of the identification IC.

### FIELD OF THE INVENTION

The present invention relates to two types of the printed radio frequency sensing cards and two methods for fabricating these two types of the printed radio frequency sensing cards.

### BACKGROUND OF THE INVENTION

The conventional radio frequency sensing cards under 1 MHz are made by the paint sheathing method and are therefore defective in design in that they contain a large number of coil revolutions, and that they contain paint sheaths which are excessively fine and are therefore susceptible to severance, thereby resulting in an increase in rejection rate. In addition, the methods for making the conventional radio frequency sensing cards are inefficient in production process and ineffective in cost control. The conventional radio frequency sensing cards are made one by one at a high cost. In addition, the conventional radio frequency sensing cards are too thick.

### SUMMARY OF THE INVENTION

It is the primary objective of the present invention to provide a printed radio frequency sensing card.

It is another objective of the present invention to provide a process for manufacturing the printed radio frequency sensing card.

It is still another objective of the present invention to provide a multilayered printed radio frequency sensing card comprising through holes as means of communication.

It is still another objective of the present invention to provide a method for fabricating the multilayered printed radio frequency sensing card.

The radio frequency sensing cards of the present invention are made by a printing method in place of the conventional paint sheathing method. The method of the present invention involves the use of the through hole bonding method to fabricate the multilayered printed radio frequency sensing card under 1 MH_{z}, preferably, under 500 KH_{z}, more preferably, under 300 KH_{z}, and most preferably, under 125 KH_{z} or in proximity of 125 KH_{z}.

A method for fabricating a printed radio frequency sensing card according to the present invention comprises the steps of:

(a) printing on one side of a printed circuit board substrate with a first coil circuit, and on other side of the printed circuit board substrate with a second coil circuit,

(b) forming a through hole on said printed circuit board substrate, and forming a conductor in said through hole so that the first coil circuit and the second coil circuit are connected with said conductor into a single coil circuit having one end on said one side and said other side;

(c) forming an implantation hole on said printed circuit board substrate, mounting an identification IC to said implantation hole, and electrically connecting said identification IC with said two ends of said single coil circuit; and

(d) providing the implanted printed circuit board substrate from the step (c) with one or more protective layers laminated therewith.

Preferably, said through hole is formed at a center of the printed circuit board substrate, the first coil circuit is wound clockwise from an outside of the printed circuit board substrate to said center, and said second coil circuit is wound clockwise from said center to said outside of the printed circuit board substrate, so that said first coil circuit and said second coil circuit are connected with said conductor to form said single coil circuit.

Preferably, in step (c) said identification IC is electrically connecting with said two ends of said single coil circuit at two points, which are on two surfaces of said identification IC.

A printed radio frequency sensing card constructed according to the present invention comprises: one or more printed circuit board substrates; and an identification IC; wherein at least one of said printed circuit board substrates is provided with two printed coil circuits, which are on two sides of said at least one of said printed circuit board substrates and connected by a through hole connection to form a single coil circuit having one end on each of said two sides, and said identification IC is mounted to said at least one of said printed circuit board substrates and is electrically connected to said two ends of said single coil circuit.

Preferably, said identification IC is electrically connected to said two ends of said single coil circuit at two points, which are on two surfaces of said identification IC.

Preferably, the printed radio frequency sensing card of the present invention comprises only one printed circuit board substrate, and said through hole connection is located substantially at a corner or center of said printed circuit board substrate. Said identification IC is substantially located at the center or corner of the printed circuit board substrate, such that said identification IC is mot overlapped with said through hole connection.

Preferably, said through hole connection is substantially located at the center of said printed circuit board substrate. Said identification IC is located substantially at the corner of said printed circuit board substrate..

The methods of the present invention are capable of producing the radio frequency sensing cards in quantity at a relatively low cost.

### BRIEF DESCRIPTION OF THE DRAWINGS

FIG. 1 shows a schematic view of a single printed radio frequency sensing card of the present invention.

FIG. 2 is a schematic view showing the bonding relationship between the identification code and the coil circuits of the present invention.

FIG. 3 shows a schematic view of a two-sheet printed radio frequency sensing card of the present invention.

FIG. 4 shows a schematic view of a three-sheet printed radio frequency sensing card of the present invention.

FIG. 5 shows a process flow chart of the present invention.

FIG. 6 shows a schematic view of the fabricating method of the present invention.

### DETAILED DESCRIPTION OF THE INVENTION

A method for fabricating a printed radio frequency sensing card according to the present invention involves a first step in which two sides of a printed circuit board substrate are printed with a plurality of coil circuits. Thereafter, the coil circuits are provided at the appropriate position thereof with a hole by punching, so as to facilitate the implanting of an identification IC. Finally, the IC-implanted circuit board substrate is provided with one or more protective layers by laminating.

The fabricating method of the present invention is characterized in design in that the coil circuits are connected by means of through holes, and that the coil circuits and the identification code (IC) are connected in an acoplanar manner.

If necessary, upon completion of the laminating process, the protective layer may be printed thereon with a decorative or advertising pattern.

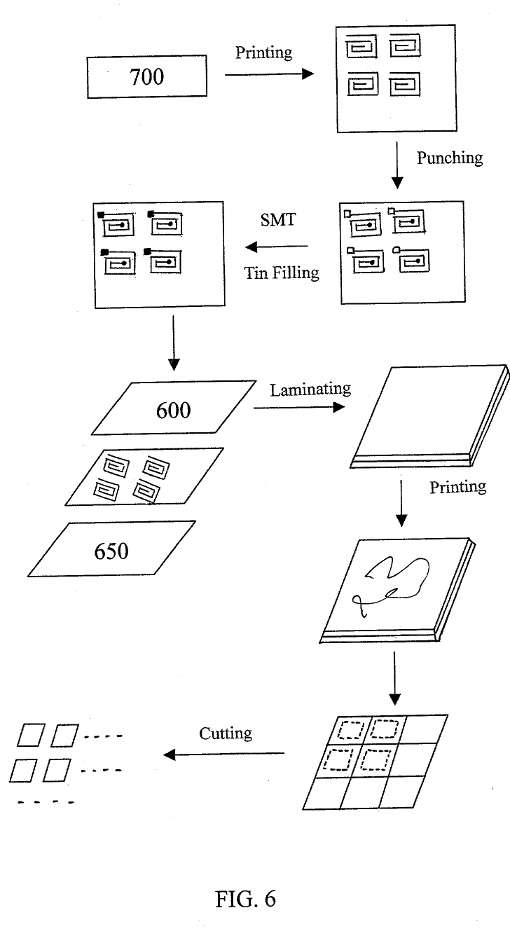

If each finished product contains a plurality of the printed radio frequency sensing cards, the finished product is cut into a plurality of the printed radio frequency sensing cards on the heels of the laminating process or the pattern-printing process, as illustrated in FIG. 6. If each finished product contains only one sheet of the printed radio frequency sensing card, the cutting process is of course omitted.

The printed circuit board (PCB) substrate referred to above is any conventional PCB substrate. The printing method of the coil circuits referred to above is any conventional circuit printing method.

The PCB substrate of the method of the present invention is punched by any conventional PCB punching method. The PCB substrate of the method of the present invention is provided with an identification IC (ID-IC) by any IC implanting method. The ID-IC of the method of the present invention is any conventional identification IC, such as radio frequency identification IC (RFID-IC).

The PCB substrate and the protective layers of the method of the present invention are laminated by any conventional laminating method.

The two coil circuits of the method of the present invention are provided with an IC-implanting hole and a coil connecting point. These two coil connecting points are substantially located oppositely on the printed circuit board substrate. For example, the connection points are located at the center of the printed circuit board substrate, or in proximity of a corner of the printed circuit board substrate. In other words, a geometric line formed by these two coil-connecting points is substantially perpendicular to the printed circuit board substrate.

The coil circuits and the identification IC of the method of the present invention are connected by a connection method conforming to the ID-IC regulation, as illustrated in FIG. 2.

The coil circuits of the present invention are conventional spiral coil circuits made of metal, and are of any pattern or shape, such as Archimedes spiral, round spiral, oval spiral, square spiral, and rectangular spiral. In light of the configuration of the printed radio frequency sensing card being rectangular, the rectangular spiral is recommended.

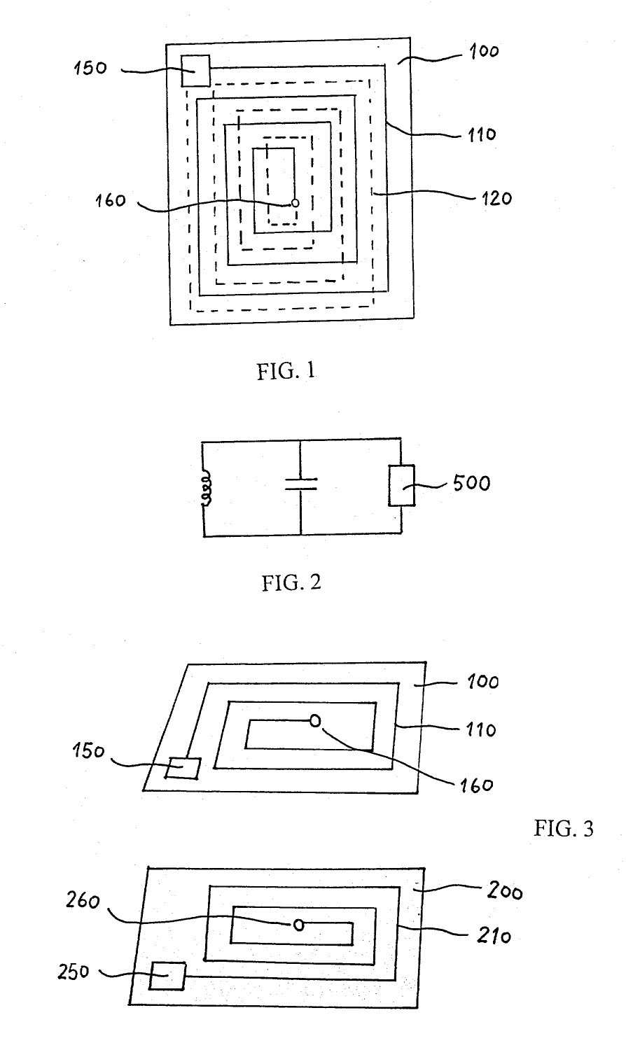

The printed circuit board substrate of the present invention has an upper side and an underside, which are printed with the coil circuits and are provided at the substantially identical position thereof with an end point. The end point is provided with a hole by punching to facilitate the filling of a conductor, such as soldering tin, so as to bond the coil circuits of the upper side and the underside of the PCB substrate together as a single coil circuit. In the meantime, another end points of the coil circuit of the upper side and the underside are connected with the IDIC to constitute an acoplanar connection. For example, the coil circuit of the upper side is connected with the identification IC, whereas the coil circuit of the underside is directly connected from the underside with the identification IC, as shown in FIG. 1.

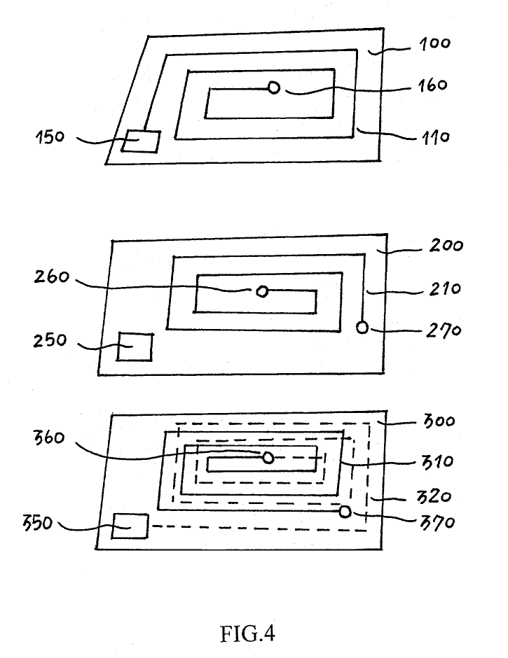

The method of the present invention can be modified to adapt to the fabrication of the multilayered printed radio frequency sensing card. For example, the multilayered PCB substrate is printed with the coil circuits to form the multilayered printed radio frequency sensing card to which the ID-IC is added by implantation, thereby enabling the coil circuits of all layers to be connected in the acoplanar manner, as illustrated in FIGS. 3 and 4. The connection of the layers is attained by the conventional PCB acoplanar connection technique.

If the multilayered printed radio frequency sensing card contains n (n>1) sheets of the PCB substrates, the number of the printed surface of the coil circuit may be n˜2n or less than n, which indicates that at least one sheet of the PCB substrate is devoid of the printed coil circuit, thereby resulting in the waste of the PCB substrate. This is not recommended. As shown in FIG. 3, n denotes 2. As shown in FIG. 4, n denotes 3.

The printed radio frequency sensing card of the present invention comprises one or more printed circuit board (PCB) substrates, and one identification (ID) IC.

The present invention is characterized by at least one of the PCB substrates, which is printed with two coil circuit surfaces. These coil circuit surfaces are connected by the through hole to form one single coil circuit, which is connected with the ID-IC in an acoplanar manner.

As shown in FIG. 1, a PCB substrate 100 of the present invention has an upper side which is provided with a printed coil circuit 110 indicated by a solid line, and an underside which is provided with a printed coil circuit 120 indicated by a dotted line. The PCB substrate 100 is provided with a first through hole 150 and a second through hole 160. The through hole 150 is intended to implant RFID-IC, whereas the second through hole 160 is used for filling the soldering tin to enable the printed coil circuits 110 and 120 to form a single coil circuit which is connected by the acoplanar connection. The printed coil circuit 110 is wound clockwise from outside to the center, and the printed coil circuit 120 is wound clockwise from the center to the outside.

As shown in FIG. 2, a RFID-IC 500 is in a parallel connection with a capacitor and the single coil circuit which is formed of the printed coil circuits 110 and 120. The RFID-IC 500 is mounted to the implantation hole 150 in FIG. 1, and two points, which are on two surfaces of the RFID-IC 500, are electrically connected to two ends of said single coil circuit.

As shown in FIG. 3, the printed radio frequency sensing card of the present invention is formed of two PCB substrates 100 and 200. The first PCB substrate 100 is provided with a printed coil circuit 110, whereas the second PCB substrate 200 is provided with a printed coil circuit 210. The first PCB substrate 100 is provided with an implantation hole 150 for implanting the RFID-IC. The second PCB substrate 200 is provided with an implantation hole 250 for implanting the RFID-IC. The first PCB substrate 100 is provided with a coil connection point 160 for filling the soldering tin. The second PCB substrate 200 is provided with a coil connection point 260 for filling the soldering tin. The printed coil circuits 110 and 120 are laminated and connected by the acoplanar connection with the soldering tin, which are wound clockwise from the implantation hole 150 through the soldering tin to the implantation hole 250.

As show in FIG. 4, the printed radio frequency sensing card of the present invention is formed of three PCB substrates 100, 200, and 300, which are respectively provided with a printed coil circuit 110, 210, 310, an IC implantation hole 150, 250, 350, and a coil connection point 160, 260, 360. The IC implantation hole 150, 250, 350, is used to implant the RFID-IC. The third PCB substrate 300 is provided on the underside with a printed coil circuit 320. The PCB substrates 200 and 300 are provided respectively with a coil connection point 270, 370. The coil connection points 160 and 260 of the substrates 100 and 200 are aligned for filling the soldering tin to enable the printed coil circuits 110 and 210 to be connected in an acoplanar manner. Similarly, the coil connection points 270 and 370 enable the printed coil circuits 210 and 310 to be connected in the acoplanar manner by a soldering tin. The coil connection point 360 is intended to enable the printed coil circuits 310 and 320 to be connected in the acoplanar manner by a soldering tin. The coil connection points 360 and 260 can not located oppositely. In other words, they are different on the X-Y coordinate. As a result, the printed coil circuits 110/210, and the printed coil circuits 310320 are not connected in the acoplanar manner via the coil connection points 260 and 360.

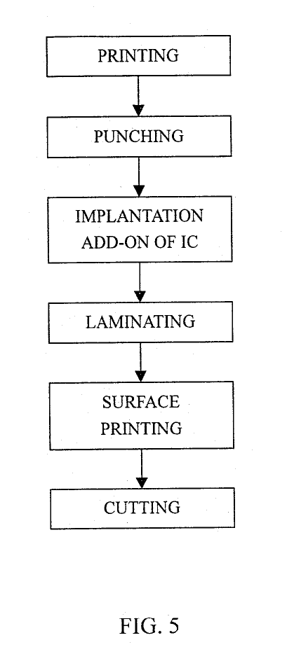

FIGS. 5 and 6 are self-explanatory in terms of the fabrication of the printed radio frequency sensing card. The printing of images on the protective layers 600 and 650 may be done before the laminating of the protective layer is completed or after the cutting process is completed. The method of the present invention is capable of fabricating continuously 1s a plurality of the printed radio frequency sensing cards with precision and at low cost by using a substrate 700, as illustrated in FIG. 6.

What is claimed is:

1. A method for fabricating a printed radio frequency sensing card, said method comprising the steps of:
(a) printing on one side of a printed circuit board substrate with a first coil circuit, and on other side of the printed circuit board substrate with a second coil circuit,
(b) forming a through hole on said printed circuit board substrate, and forming a conductor in said through hole so that the first coil circuit and the second coil circuit are connected with said conductor into a single coil circuit having one end on said one side and said other side;
(c) forming an implantation hole on said printed circuit board substrate, mounting an identification IC to said implantation hole, and electrically connecting said identification IC with said two ends of said single coil circuit; and
(d) providing the implanted printed circuit board substrate from the step (c) with one or more protective layers laminated therewith.

2. The method as defined in claim 1, wherein said through hole is formed at a center of the printed circuit board substrate, the first coil circuit is wound clockwise from an outside of the printed circuit board substrate to said center, and said second coil circuit is wound clockwise from said center to said outside of the printed circuit board substrate, so that said first coil circuit and said second coil circuit are connected with said conductor to form said single coil circuit.

3. The method as defined in claim 1, wherein in step (c) said identification IC is electrically connecting with said two ends of said single coil circuit at two points, which are on two surfaces of said identification IC.

4. A printed radio frequency sensing card comprising: one or more printed circuit board substrates; and an identification IC; wherein at least one of said printed circuit board substrates is provided with two printed coil circuits, which are on two sides of said at least one of said printed circuit board substrates and connected by a through hole connection to form a single coil circuit having one end on each of said two sides, and said identification IC is mounted to said at least one of said printed circuit board substrates and is electrically connected to said two ends of said single coil circuit.

5. The sensing card as defined in claim 4, wherein said identification IC is electrically connected to said two ends of said single coil circuit at two points, which are on two surfaces of said identification IC.

6. The sensing card as defined in claim 4 comprising only one printed circuit board substrate, and said through hole connection being located substantially at a corner or center of said printed circuit board substrate.

7. The sensing card as defined in claim 6, wherein said through hole connection is substantially located at the center of said printed circuit board substrate.

8. The sensing card as defined in claim 6, wherein said identification IC is substantially located at the center or corner of the printed circuit board substrate such that said identification IC is mot overlapped with said through hole connection.

9. The sensing card as defined in claim 7, wherein said identification IC is located substantially at the corner of said printed circuit board substrate.

10. The sensing card as defined on claim 4 being under 1 MH_{z}.

11. The sensing card as defined in claim 10 being under 300 KH_{z}.

12. The sensing card as defined in claim 11 being in the vicinity of 125 KH_{z}.
